(19) United States
(12) Patent Application Publication
(10) Pub. No.: US 2004/0047697 A1
(43) Pub. Date: Mar. 11, 2004

(54) Debris collection device for use with electrical and hand tools

(76) Inventor: Dara Cheng, San Diego, CA (US)

Correspondence Address: Eric Hanscom, Suite 104, 7040 Avenida Encinas, PMB 126, Carlsbad, CA, 92009, US

(21) Appl. No.: 10/237,286

(22) Filed: Sep. 9, 2002

(51) Int. Cl. B23B 47/34

(52) U.S. Cl. 408/67

(57) ABSTRACT

The present invention is directed to a debris collection device in which the debris collection device not only contains the debris to avoid injury to the tool user through debris falling into the user's eye, flying debris causing physical injury to the user's body, or particles causing lung injury through being inhaled by the user, but also retains the debris for easy recycling or disposal. The collection portion of this invention is adjustable with respect to its distance from the tool, allowing it to be used to effectively contain debris under a wide variety of conditions.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF INVENTION

There are a variety of manual and hand tools which are used to remove debris from a specific portion of a substance. Common examples include drills, drill presses, jackhammers, chisels, and other tools which can be powered manually, electrically by both battery and directly off an electrical outlet or generator, or by compressed air. Common substrates upon which these tools are used include wood, metals (both precious metals such as gold, silver, and copper, where saving debris would be desired, and less valuable metals such as iron and aluminum, for which recycling would not be currently economically feasible), drywall, tile, concrete, and rock. A number of debris retaining devices have been proposed in an effort to contain the debris mainly in the interests of protecting the eyes of the tool operator. These inventions however, do not adequately contain the debris such that they can be easily removed from the immediate work area and disposed or recycled. This invention not only contains the debris, but also provides an effective method of retaining the debris in a container for easy recycling or disposal depending on the value of the debris.

The '499 patent to Cuneo teaches a device for sucking up material removed by the bit of a portable drill, but the method would prove impractical for collecting the large debris that could result from jackhammers and chisels, as well as being of an impractical design for use with drill presses. The '984 patent to Cuevas also teaches a device which collects debris particles, but fails to provide a method by which the debris are collected in a container for easy disposal or recycling. The '984 patent also performs most efficiently when the tool, a drill, is used on vertical surfaces or ceilings, as opposed to the present invention which can also work efficiently on horizontal surfaces. The '971 patent to Nevills teaches a rotary end cutting tool but has no collection device. The '118 patent to Terrell teaches a downhole chemical cutter which has, in a sense, a means to contain debris from the cutting implement, but the means taught by this patent are in no way similar to that taught by the present invention.

### BRIEF SUMMARY OF INVENTION

The present invention is directed to a debris collection device in which the debris collection device not only contains the debris to avoid injury to the tool user through debris falling into the user's eye, flying debris causing physical injury to the user's body, or particles causing lung injury through being inhaled by the user, but also retains the debris for easy recycling or disposal. The collection portion of this invention is adjustable with respect to its distance from the tool, allowing it to be used to effectively contain debris under a wide variety of conditions.

It is therefore an object of this invention to provide a safety debris container which is easily attached to the tool and serves to protect the tool operator from flying debris.

It is a further object of this invention that the container can be used to collect the debris such that the debris are easily removed from the work area and either recycled or disposed of in a clean and efficient manner.

Other and further objects and features of this invention will be apparent to one skilled in the art.

### BRIEF DESCRIPTION OF THE SEVERAL VIEWS OF THE DRAWINGS

FIG. 1 is a side view of a drill press with the debris collection device attached, showing the spring-loaded adjustment bar which serves to maintain the cylinder in contact with the work surface.

FIG. 2 is partial, elevational view of the debris collection device showing the individual parts and how they attach together to form the invention.

FIG. 3 is a partial, elevational view of the cylinder holder, or tray, which can attach to the bottom of the spring-loaded adjustment bar and holds the cylinder in place.

FIG. 4 is a partial, elevational view of a debris collection device with a rotatable plate with a set of pre-drilled, sequentially sized holes of different diameters which can be rotated over a pre-drilled hole of a size at least as large as the largest hole of the sequentially sized holes in the rotatable plate.

FIG. 5 is a top view of the rotatable plate of FIG. 4.

### DETAILED DESCRIPTION OF THE INVENTION

The present invention is directed to debris collection devices for use with manual and electrical devices which are used to remove debris by means of a rotatable removal tip or tool, including debris considered useless following their removal and those with sufficient value to justify their saving and recycling) from a specific portion of the substance upon which the device is used. The preferred embodiment of this invention is, as illustrated by the figures which follow, is a debris collector used with a drill press.

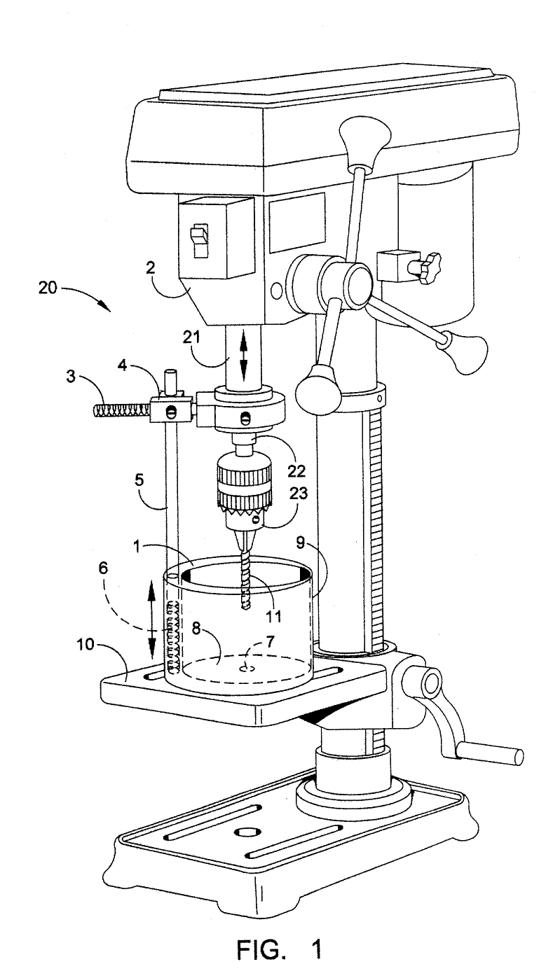

Referring to the drawings, and particularly to FIG. 1, the debris collection device is generally indicated by the reference number 1(1). To discuss briefly the operation of a drill press (generally referred to by reference number 2), the drill press has a sleeve (21), the up and down movement of which is controlled by a sleeve control (20). Below the sleeve is a spindle (22) into which fits a chuck (23) which holds in place a drill bit (11) which rotates as the spindle (22) and chuck (23) turn. As the sleeve control (20) is pulled by an operator toward himself or herself, the sleeve (21) moves down, forcing the rotating drill bit (11) into the working surface. As the drill bit moves into the working surface, it removes material from the working surface, creating a round hole as it progress down further and further into the working surface.

The debris collector includes a debris collecting cylinder (9), with a bottom (8), and, optionally, a spring-loaded adjustment bar (5) with a spring portion (6) which connects the cylinder to the tool through a three-dimensional box or rectangular-shaped connection device (4) in a manner such that as the tool is lowered onto the work surface and begins removing a portion of the work surface (10), and the tool lowers into the surface, the cylinder bottom (8) remains in close contact with the work surface (10) as the spring-loaded adjustment bar (5) keeps continuous pressure on the cylinder, forcing it against the work surface. Connecting the spring-loaded adjustment bar (5) to the sleeve (21) is a spindle attachment device (3) which is also attached to the spring-loaded adjustment bar (5) by the three-dimensional box or rectangular-shaped connection device (4) which has pre-drilled holes of the proper diameter to accommodate both the spring-loaded adjustment device and the spindle attachment. It is desired that the box or connection device (4) allows both the spindle attachment device (3) and the spring-loaded adjustment bar (5) to be adjusted to accommodate different tools and different working surfaces.

The cylinder bottom (8) is constructed such that there can be a hole (7) in it through which the drill bit (11) can pass as it drills into the work surface. In one embodiment the cylinder bottom (8) is constructed of a plastic which can be drilled through by a variety of drill bits of different diameters. Alternatively, this invention could be manufactured and sold as a series of cylinders with bottoms made of metal or other not-easily-drilled substance into which each cylinder in the set has a different size hole drilled. These sets could range from a set of three or four cylinders (small—medium—large—extra large), to a set where there is one cylinder for each size of drill in a standard, 13 piece drill set, beginning at 1/16^{th} of an inch and ending at ¼^{th} of an inch. In order to economically store these cylinder sets, it is envisioned that the cylinders could be made in sequential sizes such that each could fit inside of the next larger size.

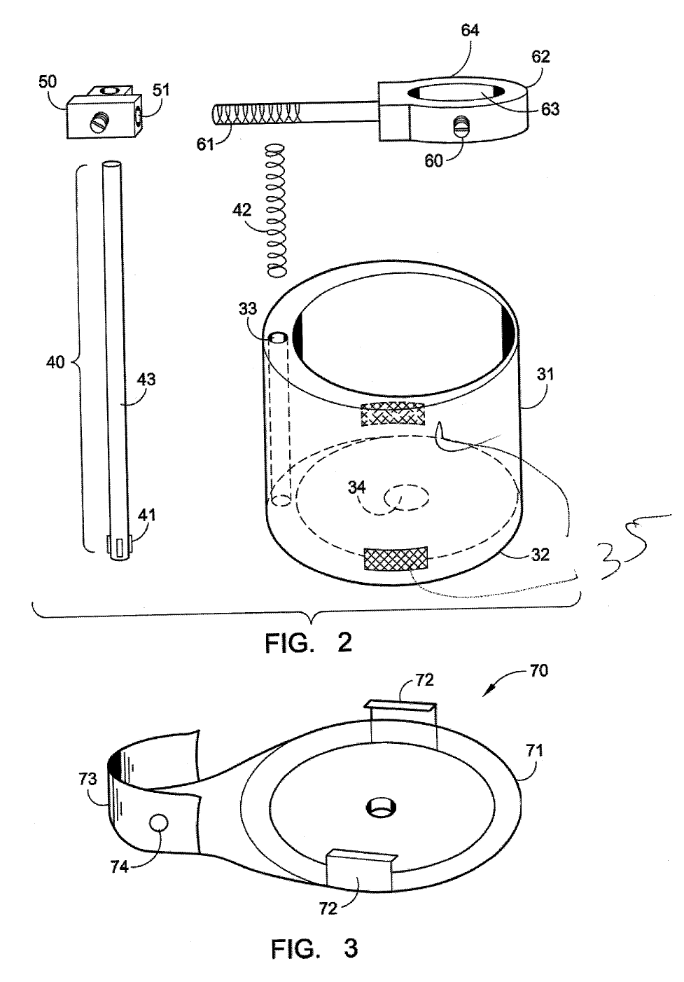

FIG. 2 and FIG. 3 show the individual parts as they appear individually and apart from the other parts. Starting with FIG. 2, the cylinder (generally indicated by reference number 31), has a bottom (32) with a hole (34), and a hole (33) drilled in one side of the cylinder to accommodate the spring-loaded adjustment (generally indicated by reference number 40), and two indentations (35) in the side which allow the tray illustrated in FIG. 3 to clamp on. The spring-loaded adjustment bar (40) is constructed of a hollow member (43) has a spring (42) embedded within the hollow member (43) and attached by way of a clamp (41). The spindle attachment device (generally referred to by reference number 60), has an adjustment end (61), and a spindle attachment end (64) comprising a spindle clamp (62) which surround a spindle cavity (63) into which the spindle fits. Attaching the spindle attachment device (60) to the spring-loaded adjustment bar (40) is a three-dimensional box or rectangular-shaped connection device (identified generally by reference number 50), which comprises a block with holes for the spring-loaded adjustment bar (40) and the adjustment end (61) of the spindle attachment device (60). The connection device (50) allows both the spring-loaded adjustment bar (40) and the spindle attachment device (60) to be adjusted for different drilling conditions.

FIG. 3 describes how the tray (generally referred to by reference number 70) is designed to attach to the bottom of the spring-loaded adjustment bar (40), and provide a stable platform upon which the debris collector cylinder (31) can rest. The tray (70) is comprised of a support ring (71) upon which the cylinder (31) rests. Extending vertically from the edges of the support ring (71) are two or more side supports (72) which serve to hold the cylinder (31) in a stable position over the support ring (71) by clamping into the indentations shown in FIG. 2 reference number 35. Attaching the support ring (71) to the spring-loaded adjustment bar (40) is a semicircular attachment device (73) which fits around the lower portion of the spring-loaded adjustment bar (40) and can be adjusted and tightened by way of an adjustment screw (74).

It is intended that this invention can be produced and sold as a series of debris collectors, all of which have similar sized and shaped cylinders and bottoms, but each of which has a different sized pre-drilled hole. This set is designed to be used with cylinders which have cylinder bottoms constructed of sturdy plastic or metal, and designed to be used with a drill bit of a certain diameter, in situations where one size of drill bit is used repeatedly. Because each container is only to be used with a drill bit of a certain size, there is no need to construct the bottoms of cylinders which are used in these sets to have cylinder bottoms capable of being drilled through.

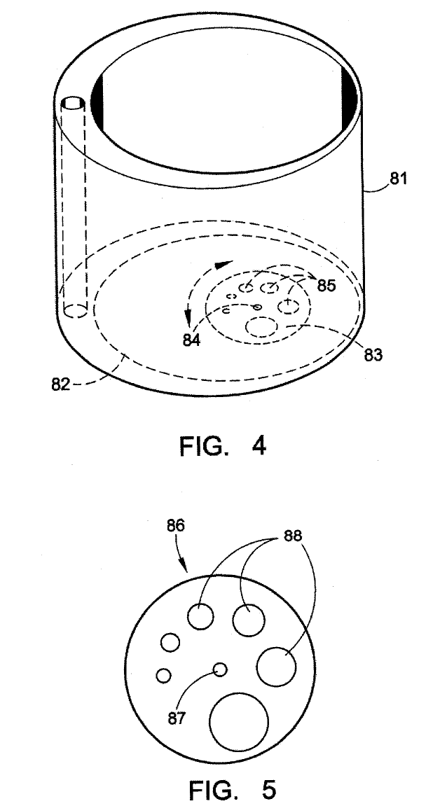

FIG. 4 refers to a cylinder (generally referred to by number 81) which has a cylinder bottom (82) with a rotatable disk (generally referred to by 83) lying above the cylinder bottom (82) attached by a rivet, small bolt, screw or other attachment method (84) which would allow the disk to rotate freely in either direction. The rotatable disk (83) would have a variety of holes (85) of different sizes arranged sequentially along the edge of the disk, such that there could be created a tight seal between different drill bits and the cylinder bottom, such that little or no debris would escape from the debris collector. This rotatable disk can be either completely smooth, in which case any friction between the disk and upper surface of the cylinder bottom must be created in the attachment, or can be made with small extrusions or bumps on its bottom which mate with similar extrusions or bumps on the upper surface of the cylinder bottom which are designed such that the rotatable disk is held stable above the hole in the cylinder bottom when each hole in the rotatable disk is lined up above the hold in the cylinder bottom.

FIG. 5 is a top view of the rotatable disk (83 in FIG. 4, generally referred to by 86 in FIG. 5), showing the central point of attachment (87) to the cylinder bottom (not shown), and the sequential series of holes (88).

It will be readily apparent to those skilled in the art that still further changes and modifications in the actual concepts described herein can readily be made without departing from the spirit and scope of the invention as defined by the following claims.

What is claimed is:

1. A debris collection device for a drill, jackhammer, and similar electrical and manually-operated tools which have, as a desired end of their operation, the removal of debris from a specific region of a substance, consisting of:
a resilient, sturdy, clear debris collection cylinder with a bottom, a hole in said bottom, and a hole in the cylinder side which can accommodate a spring-loaded adjustment bar,
a cylinder support tray designed provide a stable platform upon which the debris collection cylinder can rest comprising a support ring upon which the debris collection cylinder rests, two or more side supports extending vertically from the edges of the support ring which serve to hold the debris collection cylinder in a stable position over the support ring, a semicircular attachment device which fits around the lower portion of a spring-loaded adjustment bar and can be adjusted and tightened by way of an adjustment screw designed to attach the support ring to the spring-loaded adjustment bar,
a spindle attachment device which has an adjustment end and a spindle attachment end consisting of a spindle clamp which surrounds a spindle cavity into which the spindle fits and allows the debris collection cylinder to be attached to a non-rotating portion of the drill press,
a spring-loaded adjustment bar which consists of a hollow cylinder having an upper end and a lower end, the lower end having a clamp which holds in place a spring designed to keep the cylinder in contact with a working surface, which inserts into a pre-drilled cavity in the edge of the debris collection cylinder on its lower end, and,
a three-dimensional box or rectangular-shaped connection device which attaches the spindle attachment device to the spring-loaded adjustment bar, which comprises a block with holes for the spring-loaded adjustment bar and the adjustment end of the spindle attachment device, such connections allowing for both the spring-loaded adjustment bar and the spindle attachment device to be adjusted for different drilling conditions.

2. The debris collection device of claim 1 where,
the cylinder bottom is made of a substance such as plastic which can be perforated by said rotating portion of said tool, such that a hole is made through use of said tool that is the exact size and shape of the hole made in the substance,

3. The debris collection device of claim 2 where,
said cylinder has a cylinder top attached to the top of the cylinder which will contain debris when said tool is used on vertical surfaces and on ceilings.

4. The debris collection device of claim 3 where
the cylinder bottom of a particular cylinder is manufactured with a hole of a standard size commonly found in commercially available drill bits, such that a set of the debris collection cylinders could be manufactured and sold with a graduated series of hole sizes,

5. The debris collection device of claim 4 where,
the debris collection devices in a set are each manufactured of a size such that each debris collection device fits within, or nestles within the debris collection device which is the next size larger,

6. The debris collection of claim 4 where,
said cylinder bottom is specifically designed for use with hand and power drills with removable drill bits of various sizes, and has, pre-drilled in it, a hole of a certain size, over which is rotated a disk of diameter smaller than the diameter of said cylinder bottom, said disk having multiple holes pre-drilled in it,

7. The debris collection device of claim 6 where,
Said multiple holes range in size from the smallest bit size to the largest bit size normally used by said hand and power drills.

8. The debris collection device of claim 7 where,
Said disk has a series of extrusions or bumps which match similar sized extrusions or bumps on the upper surface of the cylinder bottom such that when a hole of the disk is rotated above the hold on the cylinder bottom, the disk is held through friction relatively stable over the hole.
